(19) United States
(12) Patent Application Publication
(10) Pub. No.: US 2016/0210014 A1
(43) Pub. Date: Jul. 21, 2016

(54) METHOD OF OPERATING INTERFACE OF TOUCHSCREEN OF MOBILE DEVICE WITH SINGLE FINGER

(71) Applicant: National Cheng Kung University, Tainan (TW)

(72) Inventors: Shuo-Fang Liu, Tainan (TW); Hsin-Hsi Lai, Tainan (TW)

(21) Appl. No.: 15/000,199

(22) Filed: Jan. 19, 2016

(30) Foreign Application Priority Data
Jan. 19, 2015 (TW) 104101640

(51) Int. Cl. G06F 3/0488; G06F 3/16; G06T 3/40

(52) U.S. Cl. CPC G06F 3/0488; G06T 3/40; G06F 3/167

(57) ABSTRACT

A method of operating an interface of a touchscreen of a mobile device with a single finger is provided to zoom in or zoom out a picture on the touchscreen of the mobile device. The method includes: touching a left region or a right region on the touchscreen of the mobile device for a predetermined time; displaying a zoom-in or zoom-out operation interface on the touchscreen of the mobile device; and applying an upward stroke or downward stroke to the zoom-in or zoom-out operation interface to zoom in or zoom out the picture. Therefore, the method renders the operation interface intuitive and user-friendly and thus fit for use by the elderly and the disabled.

### CROSS REFERENCE

The non-provisional application claims priority from Taiwan Patent Application No. 104101640, filed on Jan. 19, 2015, the content thereof is incorporated by reference herein.

### BACKGROUND OF THE INVENTION

1. Field of the Invention

The present invention relates to methods of operating an interface of a touchscreen of a mobile device and more particularly to a method of operating an interface of a touchscreen of a mobile device with a single finger, so as to render the operation interface intuitive and user-friendly and thus fit for use by the elderly and the disabled.

2. Description of the Prior Art

The human body's motor functions, sensing faculties, and cognitive abilities deteriorate with age. The elderly are clumsy in operating any applications on mobile electronic apparatuses, because of degenerative changes in their eyesight, visual search capability, fine motor functions, finger dexterity, tactile sensitivity, and the like.

There are well-known conventional ways of zooming and browsing on a touchscreen, namely using two or more fingers to exercise control, fixing a picture in place with a single finger while adjusting the size of the picture by rotating it clockwise or counterclockwise with another finger, and double-clicking to zoom in and zoom out (by clicking twice with a single finger, pressing at the end of the second click, and then pulling up and down.) The aforesaid types of motion each require manipulating sophisticated complicated gesture and thus could be difficult to the elderly.

Accordingly, it is imperative to overcome the aforesaid drawbacks of the prior art.

### SUMMARY OF THE INVENTION

In view of the aforesaid drawbacks of the prior art, the inventor of the present invention collected related data, considered and assessed the data comprehensively, conducted tests and corrections repeatedly according to the inventor's professional experience in the related industry, and eventually devised the present invention.

It is an objective of the present invention to provide a method of operating an interface of a touchscreen of a mobile device with a single finger, so as to render the operation interface intuitive and user-friendly and thus fit for use by the elderly and the disabled.

In order to achieve the above and other objectives, the present invention provides a method of operating an interface of a touchscreen of a mobile device with a single finger, adapted to zoom in or zoom out a picture on the touchscreen of the mobile device, the method comprising the steps of: touching a left region or a right region on the touchscreen of the mobile device for a predetermined time; displaying a zoom-in or zoom-out operation interface on the touchscreen of the mobile device; and applying an upward stroke or downward stroke to the zoom-in or zoom-out operation interface to zoom in or zoom out the picture.

In a preferred embodiment, the step of applying an upward stroke or downward stroke to the zoom-in or zoom-out operation interface to zoom in or zoom out the picture further comprises playing an indicative voice corresponding to the zoom-in or zoom-out operation.

In a preferred embodiment, the predetermined time is 20 milliseconds.

In a preferred embodiment, the picture is zoomed in with the upward stroke and zoomed out with the downward stroke.

The present invention effectively simplifies conventional ways of browsing pictures on a touchscreen, thereby allowing the elderly to browse pictures on a touchscreen in a manner as needed.

### BRIEF DESCRIPTION OF THE DRAWINGS

FIG. 1 is a flowchart according to a preferred embodiment of the present invention;

FIG. 2 is a schematic view 1 according to the preferred embodiment of the present invention;

FIG. 3 is a schematic view 2 according to the preferred embodiment of the present invention;

FIG. 4 is a schematic view 3 according to the preferred embodiment of the present invention; and

FIG. 5 is a schematic view 4 according to the preferred embodiment of the present invention.

### DETAILED DESCRIPTION OF THE EMBODIMENTS

The objectives, advantages, technical means, technical structures and functions of the present invention are illustrated with a preferred embodiment and described below.

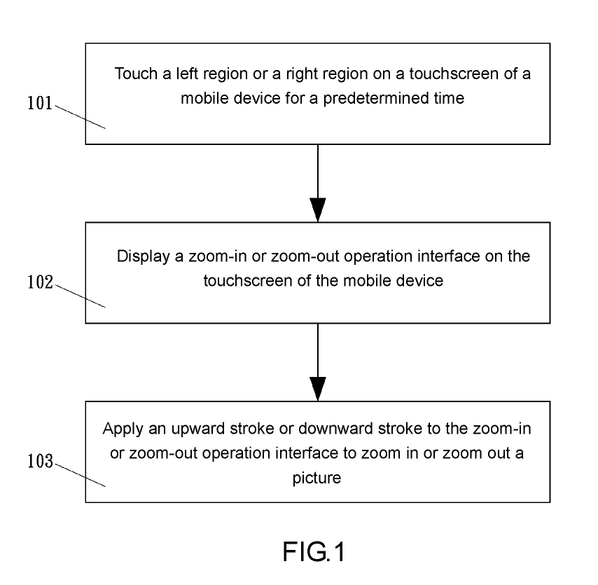

Referring to FIG. 1, there is shown a flowchart of a method of operating an interface of a touchscreen of a mobile device with a single finger according to a preferred embodiment of the present invention. With the method, a user zooms in or zooms out a picture on the touchscreen of the mobile device. The method comprises the steps of: (101) touching the left region or the right region on the touchscreen of the mobile device for a predetermined time; (102) displaying a zoom-in or zoom-out operation interface on the touchscreen of the mobile device; and (103) applying an upward stroke or downward stroke to the zoom-in or zoom-out operation interface to zoom in or zoom out the picture.

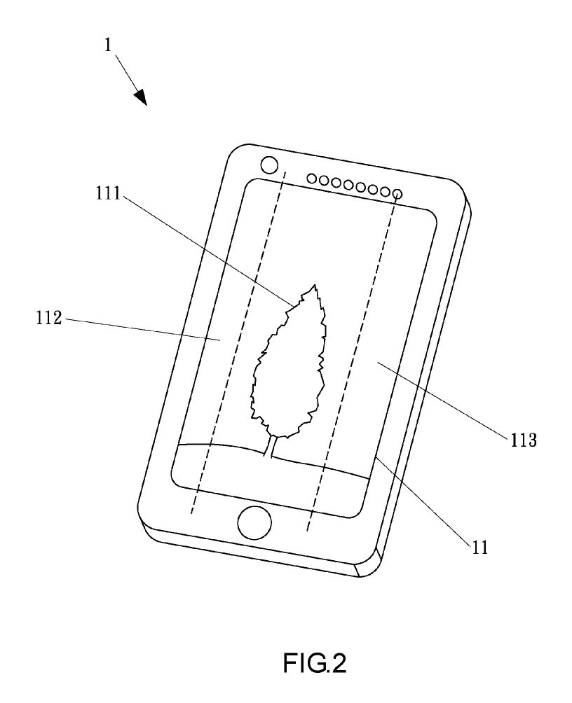

With reference to the aforesaid structures, combinations and design, the description below further explains the operation carried out with the method of the present invention. Referring to FIG. 2, in step (101), the user touches a left region 112 or a right region 113 on a touchscreen 11 of a mobile device 1 for a predetermined time of, preferably, 20 milliseconds, though a longer or shorter period of time is also feasible. Since the present invention aims to assist the elderly in operating the mobile device 1, the predetermined time is set according to the response speed of the elderly, but the present invention is not limited thereto. The mobile device 1 is a mobile electronic device, such as a mobile phone or a tablet.

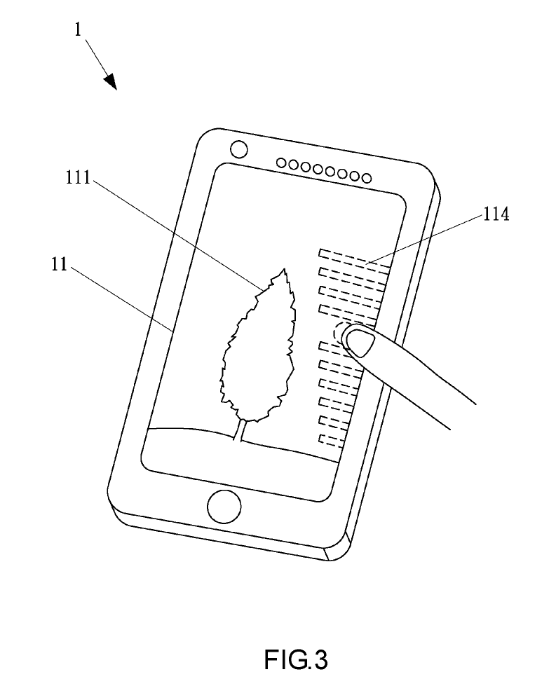

Referring to FIG. 3, after the user has touched the left region 112 or the right region 113 on the touchscreen 11 of the mobile device 1, the process flow of the method of the present invention goes to step (102) which entails displaying a zoom-in or zoom-out operation interface 114 on the touchscreen 11 of the mobile device 1. In this embodiment, the zoom-in or zoom-out operation interface 114 is presented in a pattern composed of parallel bars of different lengths. The bars are arranged in increasing length order from bottom to top; hence, the user is able to understand that the picture 111 is zoomed in with an upward stroke and zoomed out with a downward stroke. In this embodiment, which is illustrated with FIG. 3, the picture 111 shows a tree, though words or other images are also feasible.

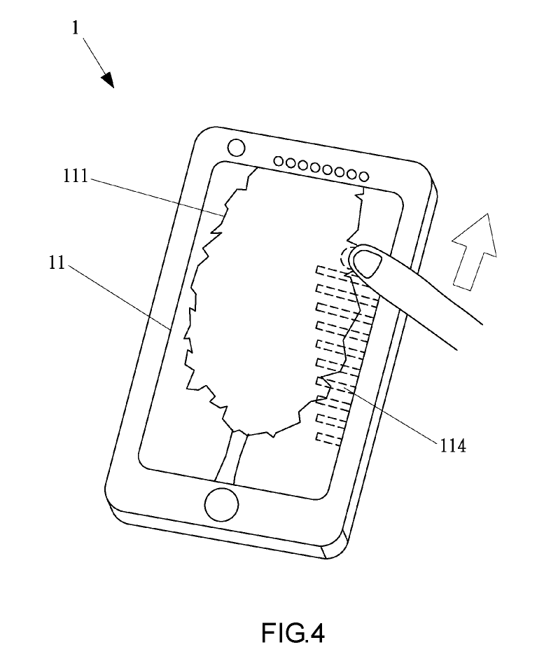

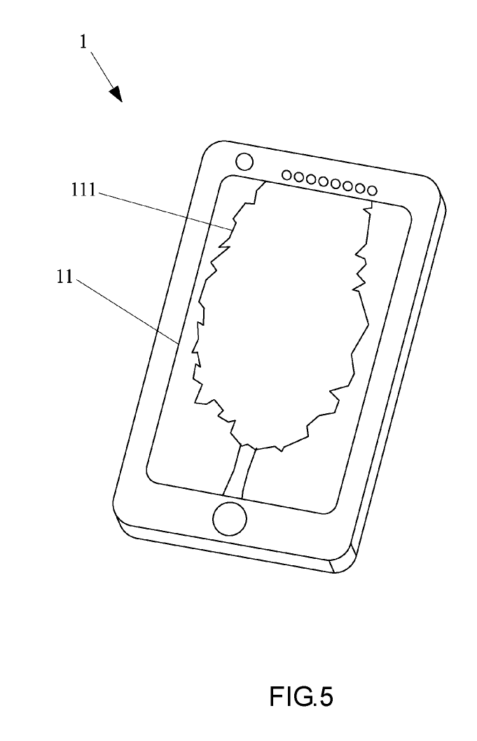

Referring to FIGS. 4 and 5, in step (103), the user applies an upward stroke or downward stroke to the zoom-in or zoom-out operation interface 114 on the touchscreen 11 of the mobile device 1 to zoom in or zoom out the picture 111. The picture 111 is zoomed in with the upward stroke and zoomed out with the downward stroke. If the user keeps touching the touchscreen 11 of the mobile device 1, the user can adjust the size of the picture 111 as needed by dragging. The user may take his or her finger away from the touchscreen 11 of the mobile device 1 as soon as the size of the picture 111 is adjusted appropriately.

The step (103) of applying an upward stroke or downward stroke to the zoom-in or zoom-out operation interface 114 to zoom in or zoom out the picture 111 further comprises playing an indicative voice corresponding to the zoom-in or zoom-out operation. For example, the mobile device 1 plays an indicative voice “zoom in the picture” to assist the elderly in zooming in the picture 111.

With the method of the present invention, the operation interface of a touchscreen of a mobile device is rendered intuitive and user-friendly and thus fit for use by the elderly. To make good use of technological advances and get along with the trend toward use of smart mobile devices, the method of the present invention controls the way of browsing pictures and text with a single finger. Hence, the method of the present invention provides a novel operation mode for the elderly and assists the elderly in controlling the interface of a mobile device in an intuitive manner, so as to integrate human intelligence, information, and a smart mobile device interface.

With reference to the accompanying drawings, unlike the prior art, the method of the present invention has advantages as follows: the present invention provides a method of operating an interface of a touchscreen of a mobile device with a single finger to render the operation interface intuitive and user-friendly and thus fit for use by the elderly and the disabled.

The present invention is disclosed above by preferred embodiments. However, the preferred embodiments should not be interpreted as restrictive of the claims of the present invention. Hence, all simple modifications and equivalent structural changes made to the aforesaid embodiments according to the disclosure contained in the specification and drawings of the present invention should fall within the scope of the claims of the present invention.

What is claimed is:

1. A method of operating an interface of a touchscreen of a mobile device with a single finger, adapted to zoom in or zoom out a picture on the touchscreen of the mobile device, the method comprising the steps of:
touching a left region or a right region on the touchscreen of the mobile device for a predetermined time;
displaying a zoom-in or zoom-out operation interface on the touchscreen of the mobile device; and
applying an upward stroke or downward stroke to the zoom-in or zoom-out operation interface to zoom in or zoom out the picture.

2. The method of claim 1, wherein the step of applying an upward stroke or downward stroke to the zoom-in or zoom-out operation interface to zoom in or zoom out the picture further comprises playing an indicative voice corresponding to the zoom-in or zoom-out operation.

3. The method of claim 1, wherein the predetermined time is 20 milliseconds.

4. The method of claim 1, wherein the picture is zoomed in with the upward stroke and zoomed out with the downward stroke.
